(19) United States
(12) Patent Application Publication
(10) Pub. No.: US 2003/0080516 A1
(43) Pub. Date: May 1, 2003

(54) Fluid seal and method of using same

(76) Inventor: Qiu Shi Zheng, Spring, TX (US)

Correspondence Address: WILLIAMS, MORGAN & AMERSON, P.C., 10333 RICHMOND, SUITE 1100, HOUSTON, TX, 77042, US

(21) Appl. No.: 10/251,492

(22) Filed: Sep. 20, 2002

Related U.S. Application Data
(60) Provisional application No. 60/323,584, filed on Sep. 20, 2001.

(51) Int. Cl. F16L 21/05

(52) U.S. Cl. 277/603

(57) ABSTRACT

A seal for inhibiting a flow of fluid through an annulus defined by a first component and a second component includes a sealing element disposed within the annulus and having at least one sealing profile in contact with a surface of the first component to inhibit a flow of fluid therebetween and means for retaining the sealing element on a surface of the second component that defines the annulus, wherein the sealing element is sealingly engaged with the second component such that a flow of the fluid is inhibited therebetween.

### BACKGROUND OF THE INVENTION

1. Field of the Invention

This invention generally relates to the field of fluid seals and, more particularly, to a method and apparatus for inhibiting a flow of fluid through an annulus.

2. Description of the Related Art

In many industries, such as the oil and gas industry, it is often desirable to provide reliable fluid seals in hostile environments. In oil and gas wells, flow control equipment associated with the well, such as Christmas trees, valves, connectors, and the like, are provided with seals that isolate the produced fluids and control fluids (e.g., hydraulic fluid and methanol) from the environment. In many wells, the produced fluid exits the well at very high pressures and temperatures. In many cases, nonmetallic or elastomeric seals commonly used in such flow control equipment may not be able to withstand the high temperature and pressure of the produced fluid. Exposure to such temperatures and pressures may cause the seals to extrude and mechanically degrade, ultimately resulting in seal failure. In oil and gas wells, there is also a risk of fire, which can damage or destroy such nonmetallic seals.

One conventional solution to these problems is to use metal-to-metal seals in place of the nonmetallic seals in areas subject to high pressure and high temperature conditions. One particular type of metal-to-metal seal is generally known as a straight bore metal seal and includes a mechanically energized sealing lip that seals against a cylindrical surface. However, in many applications, it is desirable to seal an annular space such that fluid flow is inhibited both from above the seal and from below the seal. One solution has been to use multiple seals that are generally U-shaped in cross section. The seals are inserted into an annulus such that the open end of the seal generally faces the direction from which the fluid is flowing.

Such conventional seals have several drawbacks, however. The seal assembly includes multiple components that are individually machined and installed, which leads to relatively high manufacturing and assembly costs. Such multiple seal arrangements also take up a relatively large amount of axial space and, thus, may be used only in applications wherein sufficient axial space is available within the annulus and may increase the overall length and cost of well components. Further, the legs that support the sealing lips typically have certain minimum thicknesses in order to function properly. Since the legs are disposed side-by-side, such seal arrangements may be used only where sufficient radial space is available within the annulus.

Further, such conventional metal-to-metal seals have only been used in valves as backseat stem seals, which do not contact the valve stem during normal operating conditions. Further, these seals generally are not designed to seal against fluids external to the valves, such as water in deep sea environments.

The present invention is directed to overcoming, or at least reducing, the effects of one or more of the problems set forth above.

### SUMMARY OF THE INVENTION

In one aspect of the present invention, a seal for inhibiting a flow of fluid through an annulus defined by a first component and a second component is provided. The seal includes a sealing element disposed within the annulus and having at least one sealing profile in contact with a surface of the first component to inhibit a flow of fluid therebetween and means for retaining the sealing element on a surface of the second component that defines the annulus, wherein the sealing element is sealingly engaged with the second component such that a flow of the fluid is inhibited therebetween.

In another aspect of the present invention, a seal for inhibiting a flow of fluid through an annulus defined by a first component and a second component is provided. The seal includes a sealing element disposed within the annulus, wherein the sealing element includes a first leg terminating in a first sealing profile in contact with an inner surface of the first component for inhibiting a flow of fluid within the annulus in a first direction and a second leg terminating in a second sealing profile in contact with the inner surface of the first component for inhibiting a flow of the fluid within the annulus in a second direction counter to the first direction. The sealing element further includes a tapered inner surface in a press-fit relationship with a correspondingly tapered outer surface of the second component for retaining the sealing element on the second component and for inhibiting a flow of the fluid within the annulus therebetween.

In yet another aspect of the present invention, a seal for inhibiting a flow of fluid through an annulus defined by a first component and a second component is provided. The seal includes a sealing element disposed within the annulus, wherein the sealing element includes a first leg terminating in a first sealing profile in contact with an inner surface of the first component for inhibiting a flow of fluid within the annulus in a first direction and a second leg terminating in a second sealing profile in contact with the inner surface of the first component for inhibiting a flow of the fluid within the annulus in a second direction counter to the first direction. The sealing element further includes a threaded inner surface of the sealing element engaged with a threaded portion of an outer surface of the second component for retaining the sealing element on the second component.

In another aspect of the present invention, a seal for inhibiting a flow of fluid through an annulus defined by a first component and a second component is provided. The seal includes a first sealing element having a first leg terminating in a first sealing profile in contact with the first component and a second leg terminating in a second sealing profile in contact with a flange of the second component and a second sealing element having a first leg terminating in a first sealing profile in contact with the first component and a second leg terminating in a second sealing profile in contact with the flange of the second component.

In yet another aspect of the present invention, a seal for inhibiting a flow of fluid through an annulus defined by a first component and a second component is provided. The seal includes a sealing element disposed within the annulus, wherein the sealing element includes a first leg terminating in a first sealing profile in contact with an outer surface of the first component for inhibiting a flow of fluid within the annulus in a first direction and a second leg terminating in a second sealing profile in contact with the outer surface of the first component for inhibiting a flow of the fluid within the annulus in a second direction counter to the first direction. The sealing element further includes an outer surface of the sealing element in a press-fit relationship with a corresponding inner surface of the second component for retaining the sealing element on the second component and for inhibiting a flow of the fluid within the annulus therebetween.

In another aspect of the present invention, a seal for inhibiting a flow of fluid through an annulus defined by a first component and a second component is provided. The seal includes a sealing element disposed within the annulus, wherein the sealing element includes a first leg terminating in a first sealing profile in contact with an outer surface of the first component for inhibiting a flow of fluid therebetween in a first direction and a second leg terminating in a second sealing profile in contact with the outer surface of the first component for inhibiting a flow of the fluid therebetween in a second direction counter to the first direction. The sealing element further includes a third leg terminating in a third sealing profile in contact with an inner surface of the second component for inhibiting a flow of the fluid therebetween in the first direction and a fourth leg terminating in a fourth sealing profile in contact with an inner surface of the second component for inhibiting a flow of the fluid therebetween in the second direction.

In another aspect of the present invention, a method is provided. The method includes providing a sealing element including at least one sealing profile within an annulus defined by a first component and a second component and contacting the at least one sealing profile with a surface of the first component to inhibit a flow of fluid therebetween. The method further includes retaining the sealing element on an annulus-side surface of the second component such that a flow of the fluid is inhibited therebetween.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 is a cross-sectional view of a first illustrative embodiment of a seal according to the present invention;

FIG. 2 is a cross-sectional view of a second illustrative embodiment of a seal according to the present invention;

FIG. 3 is a cross-sectional view of a third illustrative embodiment of a seal according to the present invention;

FIG. 4 is a cross-sectional view of a fourth illustrative embodiment of a seal according to the present invention;

FIG. 5 is a cross-sectional view of a fifth illustrative embodiment of a seal according to the present invention;

FIG. 6A is a cross-sectional view of a sixth illustrative embodiment of a seal according to the present invention;

FIG. 6B is an enlarged view of a portion of FIG. 6A;

FIG. 7 is a cross-sectional view of a seventh illustrative embodiment of a seal according to the present invention; and

FIG. 8 is a cross-sectional view of an eighth illustrative embodiment of a seal according to the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

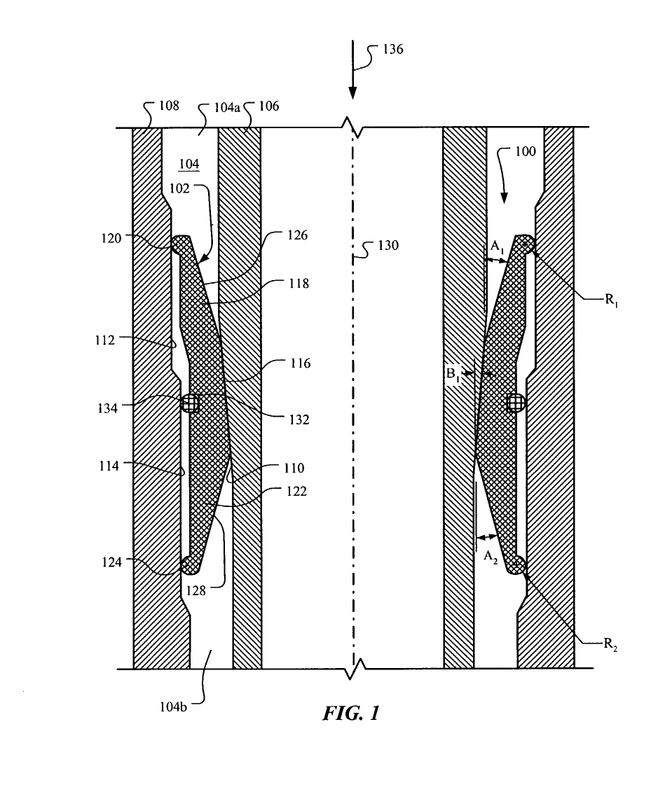

FIG. 1 illustrates, in cross-section, a first illustrative embodiment of a seal 100 according to the present invention. In the illustrated embodiment, the seal 100 includes a sealing element 102 that is generally cylindrical in shape. In use, the sealing element 102 is disposed within an annulus 104 defined by an inner component 106 and an outer component 108. In one embodiment, the inner component 106 and the outer component 108 are inner and outer well components, respectively. However, the inner component 106 and the outer component 108 may be any two generally concentric components that define an annular space (e.g., the annulus 104) therebetween. The sealing element 102 divides the annulus 104 into an upper region 104a and a lower region 104b.

The inner component 106 comprises a tapered outer surface 110. The outer component 108 includes a first inner surface 112 generally concentric with a smaller diameter second inner surface 114. In the illustrated embodiment, each of the inner surfaces 112, 114 are generally cylindrical. The sealing element 102 includes a tapered inner surface 116 that substantially matches the tapered outer surface 110 of the inner component 106. In one embodiment, each of the tapered inner surface 116 and the tapered outer surface 110 are inclined to a central axis 130 at an angle B₁, within a range of about one degree to about ten degrees. During assembly, the sealing element 102 is pressed onto the inner component 106 to retain the sealing element 102 on the inner component 106 and to create an interference fit and, thus, a reliable sealing interface therebetween. Alternatively, the sealing element 102 may be attached to the inner component 106 by heating the sealing element 102, placing the sealing element onto the inner component 106, and allowing the sealing element 102 to cool. That is, the tapered inner surface 116 is sealingly engaged with the tapered outer surface 110.

Still referring to FIG. 1, the surface finishes of the tapered surfaces 110, 116, as well as the angles of the surfaces and the amount of force used to press the sealing element 102 onto the inner component 106, are controlled so as to create a reliable seal. For example, in one embodiment, the surface finishes of one or both of the tapered surfaces 110, 116 have roughness averages (Rₐ) of no less than about 0.4 micrometers. In another embodiment, one or both of the tapered surfaces 110, 116 have a surface finish within a range of about 0.4 micrometers Rₐ and about 1.6 micrometers Rₐ.

In other embodiments, the strength of the press-fit joint may be enhanced by using the galling-inducing techniques described in U.S. Pat. No. 5,348,210 (1994, Linzell), the entirety of which is hereby incorporated by reference for all purposes. Galling is generally defined as the result of high levels of friction evenly disrupting the relevant surfaces and causing controlled transfer of the surface material from one body to the other to produce an “array” of mechanically meshing recesses and protrusions that, as a result of the intimate face-to-face contact between the two surfaces, couple together and interlock to resist further lateral motion. For example, galling may be effected by placing a galling material, such as polysiloxanes, between the surfaces to be galled. Alternatively, the surface finishes of the tapered surfaces 110, 116 may comprise an array of mechanically meshing recesses and protrusions absent galling. As a result of the intimate face-to-face contact between the two tapered surfaces 110, 116, the recesses and protrusions are coupled together and interlocked to resist further lateral motion. Irrespective of the means, the frictional force retaining the sealing element 102 on the inner component 106, in one embodiment, is at least 1.5 times a maximum anticipated force on the sealing element 102 due to pressure of the fluid within the upper region 104a of the annulus 104.

The sealing element 102 further includes a first leg 118 terminating in a first sealing profile 120 and a second leg 122 terminating in a second sealing profile 124. In one embodiment, each of the first and the second sealing profiles 120, 124 are configured such that they have radii R ₁, R₂, respectively, of about 3.3 mm. The invention, however, is not so limited. Rather, the sealing profiles 120, 124 may have any chosen radius (e.g., the radii R₁, R₂) and, further, may have any chosen shape. For example, the sealing profiles 120, 124 may have generally flat portions for sealing against the inner surfaces 112, 114. In a further embodiment, the leg 118 includes a surface 126 and the leg 122 includes a surface 128. The surfaces 126, 128 are inclined to a central axis 130 of the seal 100 at angles A₁, A₂, respectively, within a range of about one degree to about 40 degrees.

Generally, the material for the sealing element 102 is selected according to the operating pressure of the fluid within the annulus 104. For example, if the fluid within the annulus 104 has an operating pressure greater than about 70 MPa, a material having a yield strength within a range of about 700 MPa to about 850 MPa may be selected. In one embodiment, the sealing element 102 comprises a material having a yield strength within a range of about 450 MPa and about 1,000 MPa. In situations wherein the fluid within the annulus 104 is particularly corrosive, some embodiments of the present invention may be made of nickel/chromium alloys, such as Inconel® (which comprises about 76 percent nickel and about 16 percent chromium in one form), beryllium copper (which comprises about 98 percent copper and about two percent beryllium in one form), or nickel/copper alloys, such as Monel® (which comprises about 67 percent nickel and about 30 percent copper in one form).

In some embodiments, the sealing element 102 may also define a recess 132 for retaining a secondary sealing element 134. In one embodiment, secondary sealing element 134 is a ring made from an elastomeric material, such as hydrogenated nitrile rubber (HNBR) or the like. While the secondary sealing element 134 is shown in FIG. 1 as being generally circular in cross section, the invention is not so limited. Rather, the sealing element 134 may have any desired cross-sectional shape.

Still referring to FIG. 1, the sealing element 102, assembled with the inner component 106, is inserted within the outer component 108 in a direction indicated by an arrow 136 to complete the assembly of the seal 100. The larger diameter of the first inner surface 112 provides clearance for the second sealing profile 124 as the seal 100 is being assembled to reduce the likelihood of damaging the outer component 108 and, thus, prevent fluid leakage through the seal 100. The sealing element 102 is sized and configured such that the sealing profiles 120, 124 of the sealing element 102 have an interference fit with the outer component 108 when installed. The sealing profiles 120, 124 contact the first inner surface 112 and the second inner surface 114, respectively, of the outer component 108 to form a sealing interface therebetween. Further, the force exerted on the inner component 106 by the sealing element 102 as a result of the interference relationship between the sealing element 102 and the outer component 108 provides acts to further retain the sealing element 102 on the inner component 106.

When a positive net pressure exists in the upper region 104a of the annulus 104, the fluid therein exerts a force on the surface 126 of the first leg 118, thereby urging the first sealing profile 120 with greater force against the first inner surface 112 of the outer component 108. As the positive net pressure increases within the upper region 104a, the force urging the first sealing profile 120 against the first inner surface 112 increases. Thus, as the positive net pressure increases within the upper region 104a, the ability of the interface between the sealing profile 120 and the first inner surface 112 to inhibit fluid flow therethrough generally increases.

Similarly, when a positive net pressure exists in the lower region 104b of the annulus 104, the fluid therein exerts a force on the surface 128 of the second leg 122, thereby urging the second sealing profile 124 with greater force against the second inner surface 114 of the outer component 108. As the positive net pressure increases within the lower region 104b, the force urging the second sealing profile 124 against the second inner surface 114 increases. Thus, as the positive net pressure increases within the lower region 104b, the ability of the interface between the second sealing profile 124 and the second inner surface 114 to inhibit fluid flow therethrough generally increases. The physical dimensions of the legs 118, 122 should be such that they can withstand excessive deformation when pressure is applied to the surfaces 126, 128 so that the sealing engagement between the sealing profiles 120, 124 and the outer component 108 will not be adversely affected.

Accordingly, the sealing element 102 inhibits fluid within the annulus 104 from flowing between the upper region 104a and the lower region 104b. The secondary sealing element 134 inhibits fluid within the annulus 104 that might pass between the first sealing profile 120 and the first inner surface 112 or between the second sealing profile 124 and the second inner surface 114 from flowing between the upper region 104a and the lower region 104b. Further, when a positive net pressure exists in the lower region 104b of the annulus 104, which is typical during normal operation, the pressure exerts a force on the sealing element 102 to further retain the sealing element 102 on the inner component 106.

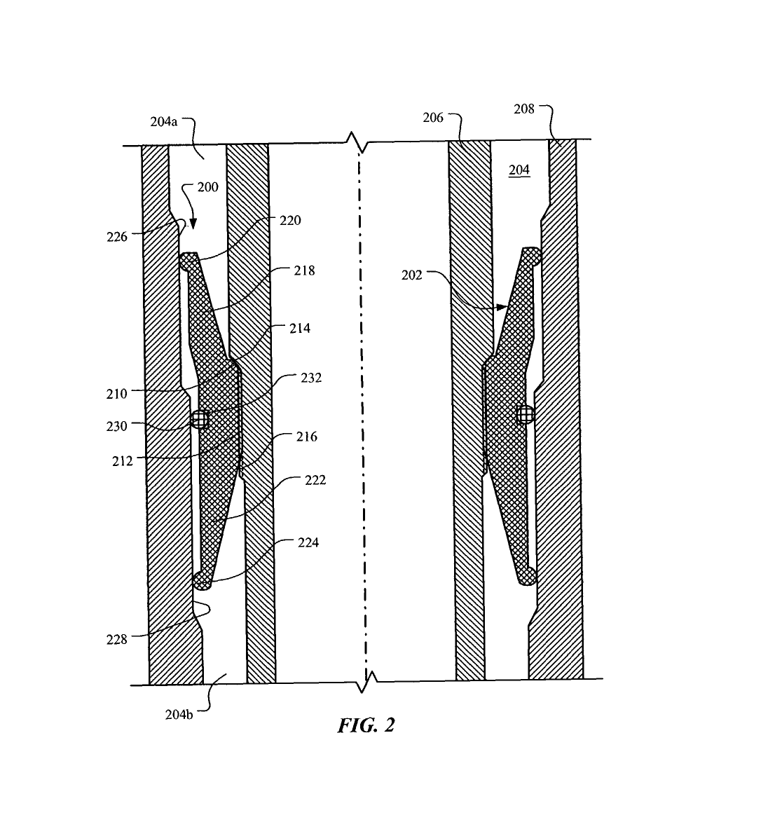

Turning now to FIG. 2, a second illustrative embodiment of the present invention is shown in cross-section. A seal 200 includes a sealing element 202 that is generally cylindrical in shape and is disposed within an annulus 204 defined by an inner component 206 and an outer component 208. The sealing element 202 divides the annulus 204 into an upper region 204a and a lower region 204b. The outer component 208 has a configuration corresponding to the outer component 108 of FIG. 1. The sealing element 202 is retained on the inner component 206 by threadedly engaging the sealing element 202 with the inner component 206, as compared to the embodiment of FIG. 1, wherein the sealing element 102 is retained on the inner component 106 via a press-fit therebetween.

Still referring to FIG. 2, the sealing element 202 includes a tapered inside surface 210 and a threaded portion 212 below the tapered inside surface 210. The inner component 206 includes a tapered outside surface 214, which substantially matches the tapered inside surface 210 of the sealing element 202. The invention, however, is not so limited. Rather, the surfaces 210, 214 may have any chosen shape so long as they are capable of providing a sealing interface therebetween. For example, one of the surfaces 210, 214 may be convexly curved and sealingly contact the other of the surfaces 210, 214. The inner component 206 further includes a threaded portion 216, which is engaged with the threaded portion 212 to retain the sealing element 202 on the inner component 206. As the sealing element 202 is advanced onto the inner component 206 during assembly, the tapered inside surface 210 contacts the tapered outside surface 214, thus creating a seal therebetween for inhibiting the flow of fluid within the annulus 204 through the engaged threaded portions 212, 216.

Similar to that of the first illustrative embodiment (shown in FIG. 1), the sealing element 202 includes a first leg 218 terminating in a first sealing profile 220 and a second leg 222 terminating in a second sealing profile 224. The sealing profiles 220, 224 seal against a first inner surface 226 and the second inner surface 228, respectively, of the outer component 208. A secondary sealing element 230 is retained in a recess 232 defined by the sealing element 202 and inhibits fluid from within the annulus 204 that might pass between the first sealing profile 220 and the first inner surface 226 or between the second sealing profile 224 and the second inner surface 228 from flowing between the upper region 204a and the lower region 204b. In other aspects, the seal 200 has features and operates in a manner similar to that of the first illustrative embodiment (shown in FIG. 1).

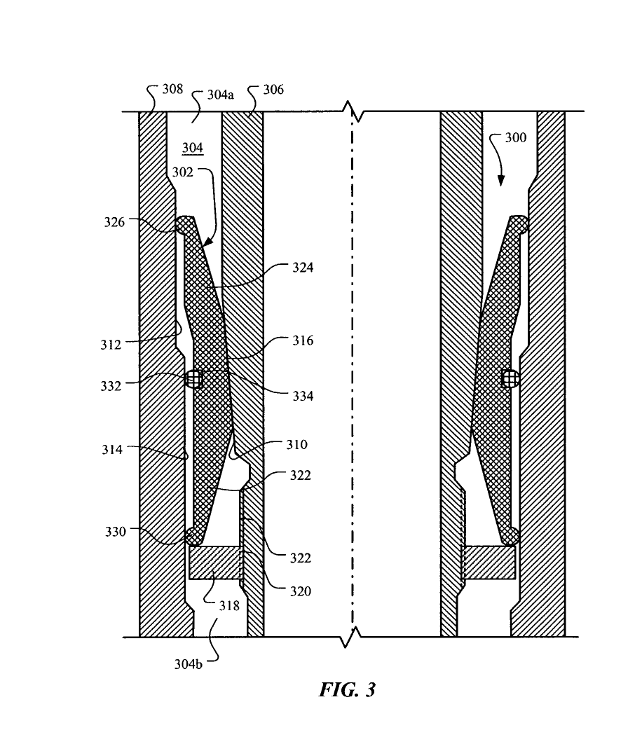

FIG. 3 depicts, in cross-section, a third illustrative embodiment of the present invention. In the illustrated embodiment, the seal 300 includes a sealing element 302 that is generally cylindrical in shape. As in the previous embodiments, the sealing element 302 is disposed within an annulus 304 defined by an inner component 306 and an outer component 308. The inner component 306 comprises a tapered outer surface 310. The outer component 308 includes a first inner surface 312 generally concentric with a smaller diameter second inner surface 314. In the illustrated embodiment, each of the inner surfaces 312, 314 is generally cylindrical. The sealing element 302 includes a tapered inner surface 316 that substantially matches the tapered outer surface 310 of the inner element 306. During assembly, the sealing element 302 is pressed onto the inner component 306 to retain the sealing element 302 on the inner component 306 and to create a seal therebetween.

Additionally, as compared to the first illustrative embodiment (shown in FIG. 1), the seal 300 includes a retaining nut 318 having a threaded portion 320 that is engaged with a threaded portion 322 of the inner component 306. During assembly, the retaining nut 318 contacts the sealing element 302 as the retaining nut 318 is advanced along the threaded portion 322 of the inner component 306. When sufficiently tightened against the sealing element 302, the retaining nut 318 inhibits the sealing element 302 from becoming dislodged from the inner component 306.

As in the first illustrative embodiment (shown in FIG. 1), the sealing element 302 includes a first leg 324 terminating in a first sealing profile 326 and a second leg 322 terminating in a second sealing profile 330. The sealing profiles 326, 330 seal against the first inner surface 312 and the second inner surface 314, respectively, of the outer component 308. A secondary sealing element 332 is retained in a recess 334 defined by the sealing element 302 and inhibits fluid from within the annulus 304 that might pass between the first sealing profile 326 and the first inner surface 312 or between the second sealing profile 330 and the second inner surface 314 from flowing between the upper region 304a and the lower region 304b. In other aspects, the seal 300 comprises features and operates in a manner similar to that of the first illustrative embodiment (shown in FIG. 1).

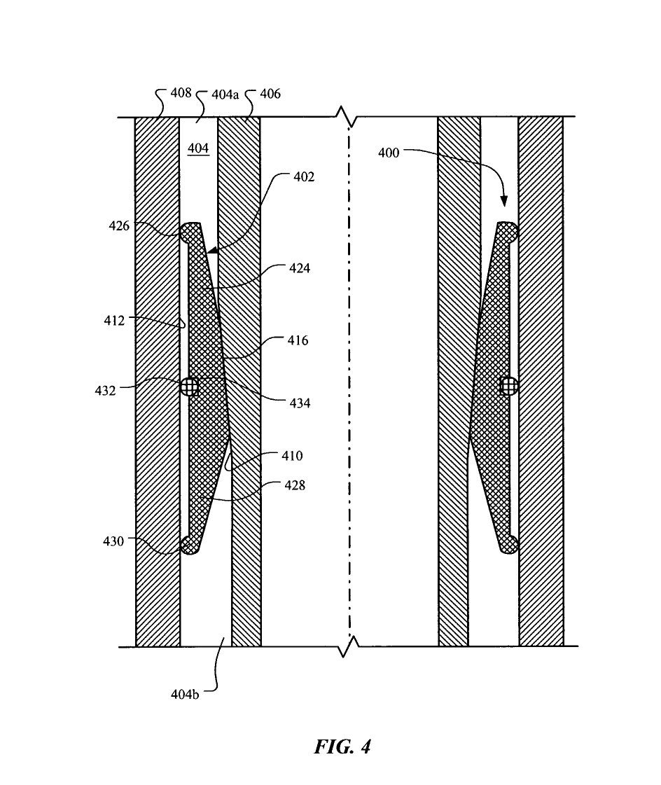

FIG. 4 depicts, in cross-section, a fourth illustrative embodiment of the present invention. In the illustrated embodiment, the seal 400 includes a sealing element 402 that is generally cylindrical in shape. As in the previous embodiments, the sealing element 402 is disposed within an annulus 404 defined by an inner component 406 and an outer component 408. The inner component 406 comprises a tapered outer surface 410. The outer component 408 includes generally cylindrical inner surface 412, rather than the stepped inner surfaces 112, 114 of the first illustrative embodiment (shown in FIG. 1). The sealing element 402 includes a tapered inner surface 416 that substantially matches the tapered outer surface 410 of the inner element 406. During assembly, the sealing element 402 is pressed onto the inner component 406 to retain the sealing element 402 on the inner component 406 and to create a seal therebetween.

As in the first illustrative embodiment (shown in FIG. 1), the sealing element 402 includes a first leg 424 terminating in a first sealing profile 426 and a second leg 428 terminating in a second sealing profile 430. The sealing profiles 426, 430 seal against the inner surface 412 of the outer component 408. A secondary sealing element 432 is retained in a recess 434 defined by the sealing element 402 and inhibits fluid from within the annulus 404 that might pass between the first sealing profile 426 and the inner surface 412 or between the second sealing profile 430 and the inner surface 412 from flowing between the upper region 404a and the lower region 404b. In other aspects, the seal 400 comprises features and operates in a manner similar to that of the first illustrative embodiment (shown in FIG. 1). Further, the seal 400 may be modified to incorporate the retaining nut 318, having the threaded portion 320, and the threaded portion 322 of the inner component 306, as shown in FIG. 3.

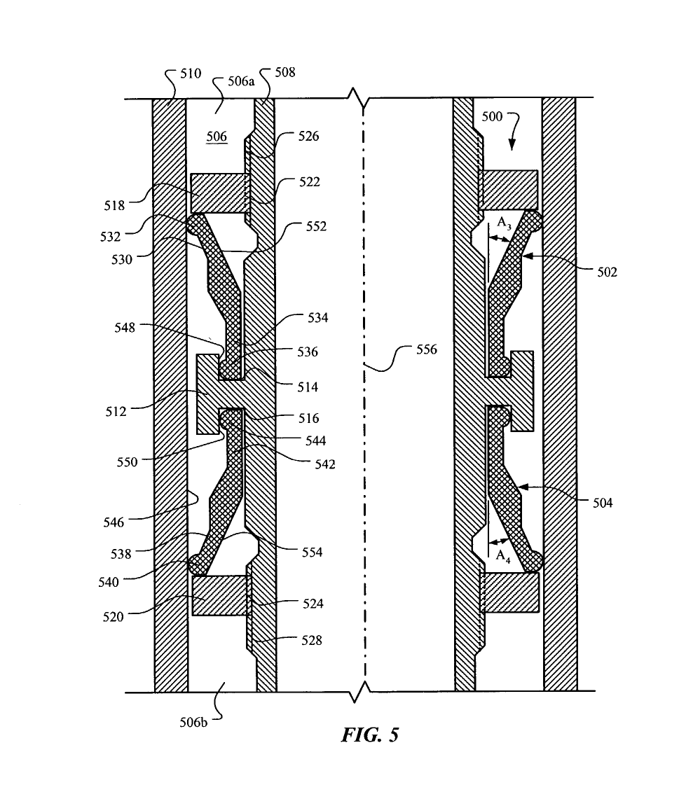

A fifth illustrative embodiment according to the present invention is shown in FIG. 5. In the illustrated embodiment, a seal 500 includes an upper sealing element 502 and a lower sealing element 504 that are each generally cylindrical in shape. In use, the sealing elements 502, 504 are disposed within an annulus 506 defined by an inner component 508 and an outer component 510. The inner component 508 comprises an outwardly extending T-shaped flange 512 that defines an upper recess 514 and a lower recess 516. The upper sealing element 502 is received in the upper recess 514 and the lower sealing element 504 is received in the lower recess 516.

The seal 500 further includes an upper retaining nut 518 and a lower retaining nut 520 for urging the sealing elements 502, 504, respectively, into the recesses 514, 516, respectively and for retaining the sealing elements 502, 504 therein. The upper retaining nut 518 includes a threaded portion 522 and the lower retaining nut 520 includes a threaded portion 524. The threaded portion 522 engages a threaded portion 526 of the inner component 508 and the threaded portion 524 engages a threaded portion 528 of the inner component 508. During assembly, the retaining nuts 518, 520 contact the sealing elements 502, 504 as the retaining nuts 518, 520 are advanced along the threaded portions 526, 528 of the inner component 508. When sufficiently tightened against the sealing elements 502, 504, the retaining nuts 518, 520 prevent the sealing element 518, 520 from becoming dislodged from the recesses 514, 516.

The upper sealing element 502 further includes a first leg 530 terminating in a first sealing profile 532 and a second leg 534 terminating in a second sealing profile 536. Further, the lower sealing element 504 includes a first leg 538 terminating in a first sealing profile 540 and a second leg 542 terminating in a second sealing profile 544. The sealing elements 502, 504, when installed within the annulus 506, are configured such that they have interference fits between the inner component 508 and the outer component 510. The first sealing profile 532 of the upper sealing element 502 seals against an inner surface 546 of the outer component 510 and the second sealing profile 536 seals against a surface 548 of the flange 512. Similarly, the first sealing profile 540 of the lower sealing element 504 seals against the inner surface 546 of the outer component 510 and the second sealing profile 544 seals against a surface 550 of the flange 512.

When a positive net pressure exists in an upper region 506a of the annulus 506, the fluid therein exerts a force on a surface 552 of the upper sealing element 502, thereby urging the first sealing profile 532 with greater force against the inner surface 546 of the outer component 510 and urging the second sealing profile 536 with greater force against the surface 548 of the flange 512. Similarly, when a positive net pressure exists in a lower region 506b of the annulus 506, the fluid therein exerts a force on a surface 554 of the lower sealing element 504, thereby urging the first sealing profile 540 with greater force against the inner surface 546 of the outer component 510 and urging the second sealing profile 544 with greater force against the surface 550 of the flange 512.

Accordingly, the sealing elements 502, 504 inhibit fluid within the annulus 506 from flowing between the upper region 506a and the lower region 506b. In other aspects, features of the seal 500 comprise attributes similar to those of the other illustrative embodiments (shown in FIGS. 1-4). In one embodiment, each of the surfaces 552, 554 are inclined relative to a central axis 556 of the seal 500 at angles A₃, A₄, respectively, within a range of about one degree to about 40 degrees.

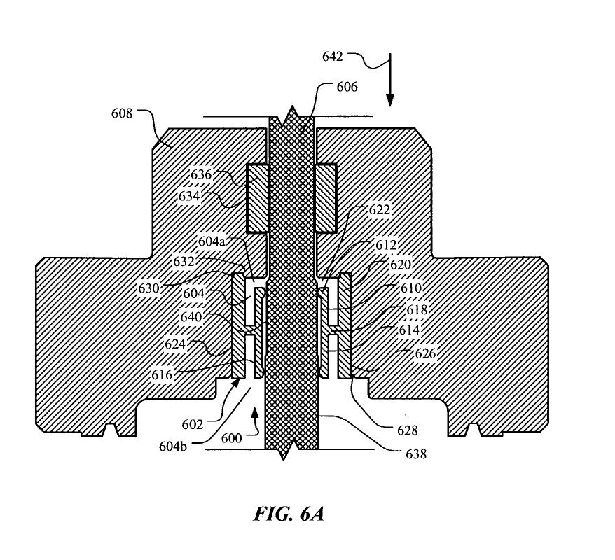

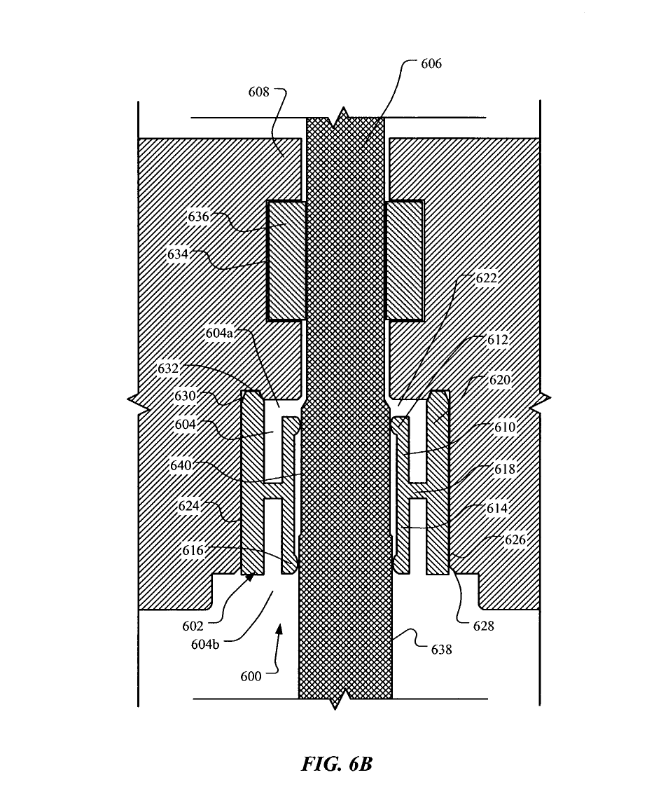

FIG. 6A depicts, in cross-section, a sixth illustrative embodiment of the present invention. In the illustrated embodiment, a generally cylindrical seal 600 includes a sealing element 602 and is disposed within an annulus 604 defined by an inner component 606 and an outer component 608. FIG. 6B provides an enlarged view of the seal 600. In one embodiment, the inner component 606 comprises a valve stem and the outer component 608 comprises a valve bonnet. However, as in the previous illustrative embodiments, the inner component 606 and the outer component 608 may be any two generally concentric components that define an annular space (e.g., the annulus 604) therebetween. The sealing element 602 divides the annulus 604 into an upper region 604a and a lower region 604b.

The sealing element 602 further includes a first leg 610, terminating in a first sealing profile 612, and a second leg 614, terminating in a second sealing profile 616. A web 618 extends between the legs 610, 614 and an anchor portion 620. The sealing element 602 is disposed in an internal seal gland 622 defined by the outer component 608. In the illustrated embodiment, an outer surface 624 of the anchor portion 620 is in a press fit or interference fit relationship with an inner surface 626 of the outer component 608, such that the sealing element 602 is retained within the seal gland 622 under operating conditions and a seal is formed between the sealing element 602 and the outer component 608. In one embodiment, the outer component 608 includes a chamfer 628 that serves to guide the sealing element 602 into the seal gland 622 during installation.

In the illustrated embodiment, the anchor portion 620 extends into a recess 630 defined by the outer component 608 such that the anchor portion 620 has a press fit or interference fit relationship with the outer component generally at 632. This relationship between the anchor portion 620 and the outer component 608 provides additional sealing between the sealing element 602 and the outer component 608.

In some embodiments, the outer component 608 may also define a recess 634 for retaining a secondary sealing element 636, which may be made from an elastomeric material such as polyetheretherketone (PEEK), polytetrafluoroethylene (PTFE), or the like. While the secondary sealing element 636 is shown in FIG. 6 as being generally rectangular in cross section, the invention is not so limited. Rather, the secondary sealing element 636 may have any desired cross-sectional shape.

Still referring to FIG. 6, the inner component 606 includes a first outer surface 638 that is generally concentric with a smaller diameter second outer surface 640. In the illustrated embodiment, each of the outer surfaces 638, 640 is generally cylindrical. The sealing element 602, assembled with the outer component 608, is placed around the inner component 606 in a direction indicated by an arrow 642 to complete the assembly of the seal 600. The smaller diameter of the second outer surface 640 provides clearance for the second sealing profile 616 as the seal 600 is being assembled. The sealing element 602 is configured such that the sealing element 602 has an interference fit with the inner component 606 when installed. The sealing profiles 616, 612 seal against the first outer surface 638 and the second outer surface 640, respectively, of the inner component 606.

Alternatively, the inner component 606 may include an outer surface having a generally constant diameter, rather than the surfaces 638, 640 of different diameters. In such an embodiment, the sealing assembly 602 is adapted such that the sealing profiles 612, 616 seal against the alternative outer surface of the inner component 606.

When a positive net pressure exists in the upper region 604a of the annulus 604, the fluid therein exerts a force on the first leg 610, thereby urging the first sealing profile 612 with greater force against the second outer surface 640 of the inner component 606. As the positive net pressure increases within the upper region 604a, the force urging the first sealing profile 612 against the second outer surface 640 increases, thus further inhibiting a flow of fluid between the first sealing profile 612 and the second outer surface 640.

Similarly, when a positive net pressure exists in the lower region 604b of the annulus 604, the fluid therein exerts a force on the second leg 614, thereby urging the second sealing profile 616 with greater force against the first outer surface 638 of the inner component 606. As the positive net pressure increases within the lower region 604b, the force urging the second sealing profile 616 against the first outer surface 638 increases, thus further inhibiting a flow of fluid between the second sealing profile 616 and the first outer surface 638.

Accordingly, the sealing element 602 inhibits fluid within the annulus 604 from flowing between the upper region 604a and the lower region 604b. The secondary sealing element 636 inhibits fluid external to the outer component 608 from entering the upper region 604a of the annulus 604. Should the secondary sealing element 636 fail, the sealing element 602 inhibits such external fluid from entering the lower region 604b of the annulus 604.

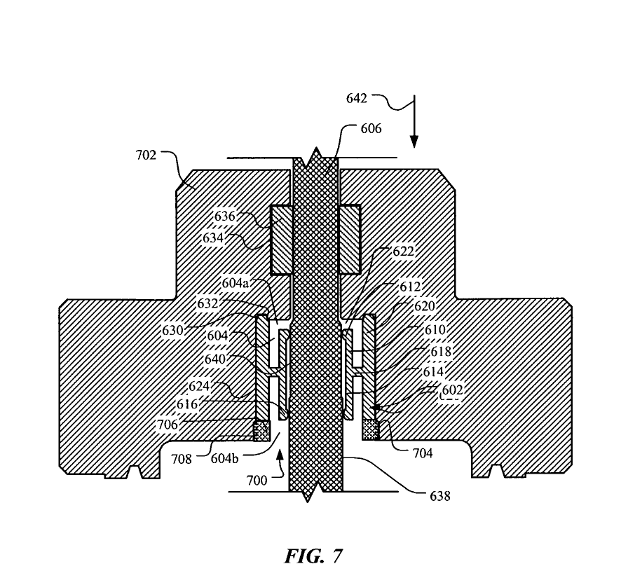

FIG. 7 shows a seventh illustrative embodiment of the present invention. A seal 700 generally comprises the elements of the sixth illustrative embodiment (shown in FIG. 6) except for the outer component 608 and these common elements are so numbered. Further, the seal 700 includes an outer component 702 generally including the same features as the outer component 608 and further including a threaded portion 704. The seal 700 also includes a retaining nut 706 having a threaded portion 708 engageable with the threaded portion 704 of the outer component 702. When installed as shown in FIG. 7, the retaining nut 706 retains the sealing element 602 within the seal gland 622. In some embodiments, less interaction is needed by the press fit or interference fit of the sealing element 602 into the seal gland 622 to retain the sealing element 602 therein due to the retaining characteristics of the retaining nut 706.

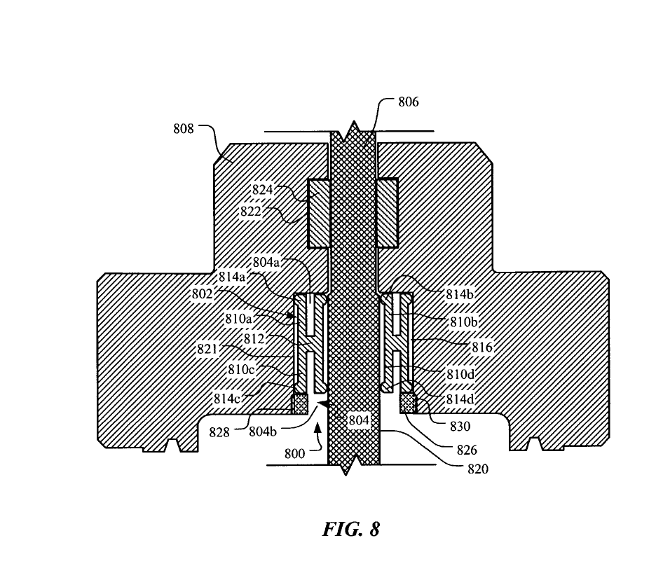

FIG. 8 depicts, in cross section, an eighth illustrative embodiment of the present invention. In the illustrated embodiment, a seal 800 includes a generally cylindrical sealing element 802. The sealing element 802 is disposed within an annulus 804 defined by an inner component 806 and an outer component 808. The sealing element 802 further includes four legs 810a, 810b, 810c, and 810d extending from a web 812. Each of the legs 810a, 810b, 810c, 810d terminate in sealing profiles 814a, 814b, 814c, 814d, respectively. The sealing element 802 is disposed in an internal seal gland 816 defined by the outer component 808. In the illustrated embodiment, the sealing element 802 is in a press fit or interference fit relationship with both the outer component 808 and the inner component 806 as a result of contact between the sealing profiles 814a, 814cwith an outer surface 820 of the inner component 806 and the contact between the sealing profiles 814b, 814d with an inner surface 821 of the outer component 808.

When a positive net pressure exists in an upper region 804a of the annulus 804, the fluid therein exerts a force on the legs 810a, 810b of the sealing element 802, thereby urging the sealing profiles 814a, 814b with greater force against the outer component 808 and the inner component 806. Similarly, when a positive net pressure exists in a lower region 804b of the annulus 804, the fluid therein exerts a force on the legs 810c, 810d of the sealing element 802, thereby urging the sealing profiles 814c, 814c with greater force against the outer component 808 and the inner component 806. Thus, the sealing element 802 inhibits fluid within the annulus 804 from flowing between the upper region 804a and the lower region 804b.

The outer component 808 may also define a recess 822 for retaining a secondary sealing element 824, as described relative to the illustrative embodiments shown in FIGS. 6 and 7. The secondary sealing element 824 inhibits fluid external to the outer component 808 from entering the upper region 804a of the annulus 804. Should the secondary sealing element 824 fail, the sealing element 802 inhibits such external fluid from entering the lower region 804b of the annulus 804.

In the illustrated embodiment, the seal 800 further comprises a retaining nut 826 having a threaded portion 828 engageable with a threaded portion 830 of the outer component 808. When installed as shown in FIG. 8, the retaining nut 826 retains the sealing element 802 within the seal gland 816.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A seal for inhibiting a flow of fluid through an annulus defined by a first component and a second component, the seal comprising:
a sealing element disposed within the annulus and having at least one sealing profile in contact with a surface of the first component to inhibit a flow of fluid therebetween; and
means for retaining the sealing element on a surface of the second component that defines the annulus,
wherein the sealing element is sealingly engaged with the second component such that a flow of the fluid is inhibited therebetween.

2. A seal, according to claim 1, wherein the means for retaining the sealing element comprises a tapered inner surface of the sealing element in a press-fit relationship with a correspondingly tapered outer surface of the second component.

3. A seal, according to claim 2, wherein the means for retaining the sealing element further comprises a retaining nut threadedly engaged with the second component.

4. A seal, according to claim 1, wherein the means for retaining the sealing element comprises a threaded portion of an inner surface of the sealing element engaged with a corresponding threaded portion of an outer surface of the second component.

5. A seal, according to claim 1, wherein the means for retaining the sealing element comprises a retaining nut threadedly engaged with the second component and in contact with the sealing element.

6. A seal, according to claim 1, wherein the means for retaining the sealing element comprises an outer surface of the sealing element in a press-fit relationship with an inner surface of the second component.

7. A seal, according to claim 6, wherein the means for retaining the sealing element further comprises a retaining nut threadedly engaged with the second component and in contact with the sealing element.

8. A seal for inhibiting a flow of fluid through an annulus defined by a first component and a second component, the seal comprising:
a sealing element disposed within the annulus and comprising:
a first leg terminating in a first sealing profile in contact with an inner surface of the first component for inhibiting a flow of fluid within the annulus in a first direction;
a second leg terminating in a second sealing profile in contact with the inner surface of the first component for inhibiting a flow of the fluid within the annulus in a second direction counter to the first direction; and
a tapered inner surface of the sealing element in a press-fit relationship with a correspondingly tapered outer surface of the second component for retaining the sealing element on the second component and for inhibiting a flow of the fluid within the annulus therebetween.

9. A seal, according to claim 8, wherein each of the tapered inner surface and the tapered outer surface are inclined at an angle within a range of about one degree to about ten degrees with respect to a central axis of the seal.

10. A seal, according to claim 8, wherein each of the first and second sealing profiles includes a contoured surface in contact with the surface of the first component to inhibit the flow of the fluid therebetween.

11. A seal, according to claim 10, wherein each of the contoured surfaces have a radius of about 3.3 mm.

12. A seal, according to claim 8, wherein the sealing element comprises a material having a yield strength within a range of about 450 MPa to about 1,000 MPa.

13. A seal according to claim 8, wherein the sealing element comprises a material selected from the group consisting of beryllium copper, a nickel/copper alloy, and a nickel/chromium alloy.

14. A seal, according to claim 8, wherein at least one of the legs further comprises a surface inclined at an angle within a range of about one degree to about 40 degrees with respect to a central axis of the seal.

15. A seal, according to claim 8, wherein the sealing profiles have an interference fit relationship with the inner surface of the first component.

16. A seal, according to claim 8, wherein:
an outside diameter of the first sealing profile is larger than an outside diameter of the second sealing profile;
the first sealing profile is in contact with a first portion of the inner surface of the first component; and
the second sealing profile is in contact with a second, smaller diameter, portion of the inner surface of the first component.

17. A seal, according to claim 8, further comprising a secondary sealing element disposed in a recess defined by the sealing element and in contact with the inner surface of the first component, such that the fluid within the annulus is inhibited from flowing therebetween.

18. A seal, according to claim 17, wherein the secondary sealing element further comprises an elastomeric material.

19. A seal, according to claim 8, further comprising a retaining nut threadedly engaged with the second component and in contact with the sealing element for further retaining the sealing element on the second component.

20. A seal, according to claim 8, wherein the tapered inner surface of the sealing element and the tapered outer surface of the second member are galled.

21. A seal, according to claim 8, wherein each of the tapered inner surface of the sealing element and the tapered outer surface of the second member further comprise recesses and protrusions that are mechanically meshed for retaining the sealing element on the second component.

22. A seal, according to claim 8, wherein each of the tapered inner surface and the tapered outer surface has a surface finish of no less than about 0.4 micrometers Rₐ.

23. A seal, according to claim 8, wherein each of the tapered inner surface and the tapered outer surface has a surface finish within a range of about 0.4 micrometers Rₐ and about 1.6 micrometers Rₐ.

24. A seal for inhibiting a flow of fluid through an annulus defined by a first component and a second component, the seal comprising:
a sealing element disposed within the annulus and comprising:
a first leg terminating in a first sealing profile in contact with an inner surface of the first component for inhibiting a flow of fluid within the annulus in a first direction;
a second leg terminating in a second sealing profile in contact with the inner surface of the first component for inhibiting a flow of the fluid within the annulus in a second direction counter to the first direction; and
a threaded inner surface of the sealing element engaged with a threaded portion of an outer surface of the second component for retaining the sealing element on the second component.

25. A seal, according to claim 24, wherein each of the first and second sealing profiles includes a contoured surface in contact with the surface of the first component to inhibit the flow of the fluid therebetween.

26. A seal, according to claim 25, wherein each of the contoured surfaces have a radius of about 3.3 mm.

27. A seal, according to claim 24, wherein the sealing element comprises a material having a yield strength within a range of about 450 MPa to about 1,000 MPa.

28. A seal, according to claim 24, wherein the sealing element comprises a material selected from the group consisting of beryllium copper, a nickel/copper alloy, and a nickel/chromium alloy.

29. A seal, according to claim 24, wherein at least one of the legs further comprises a surface inclined at an angle within a range of about one degree to about 40 degrees with respect to a central axis of the seal.

30. A seal, according to claim 24, wherein the sealing profiles have an interference fit relationship with the inner surface of the first component.

31. A seal, according to claim 24, wherein:
an outside diameter of the first sealing profile is larger than an outside diameter of the second sealing profile;
the first sealing profile is in contact with a first portion of the inner surface of the first component; and
the second sealing profile is in contact with a second, smaller diameter, portion of the inner surface of the first component.

32. A seal, according to claim 24, further comprising a secondary sealing element disposed in a recess defined by the sealing element and in contact with the inner surface of the first component, such that the fluid within the annulus is inhibited from flowing therebetween.

33. A seal, according to claim 32, wherein the secondary sealing element further comprises an elastomeric material.

34. A seal, according to claim 24, wherein the sealing element further comprises a tapered inner surface in contact with a corresponding tapered outer surface of the second component for inhibiting a flow of the fluid therebetween.

35. A seal, according to claim 24, wherein each of the threaded inner surface of the sealing element and the threaded portion of the outer surface of the second component are galled.

36. A seal, according to claim 24, wherein each of the tapered inner surface of the sealing element and the tapered outer surface of the second member further comprise recesses and protrusions that are mechanically meshed for retaining the sealing element on the second component.

37. A seal for inhibiting a flow of fluid through an annulus defined by a first component and a second component, the seal comprising:
a first sealing element having a first leg terminating in a first sealing profile in contact with the first component and a second leg terminating in a second sealing profile in contact with a flange of the second component; and
a second sealing element having a first leg terminating in a first sealing profile in contact with the first component and a second leg terminating in a second sealing profile in contact with the flange of the second component.

38. A seal, according to claim 37, further comprising:
a first retaining nut threadedly engaged with the second component and in contact with the first sealing element for retaining the first sealing profile of the first sealing element in contact with the inner surface of the first component and for retaining the second sealing profile of the first sealing element in contact with the flange of the second component; and
a second retaining nut threadedly engaged with the second component and in contact with the second sealing element for retaining the first sealing profile of the second sealing element in contact with the inner surface of the first component and for retaining the second sealing profile of the second sealing element in contact with the flange of the second component.

39. A seal, according to claim 37, wherein each of the first sealing profiles includes a contoured surface in contact with the inner surface of the first component for inhibiting a flow of the fluid therebetween and each of the second sealing profiles includes a contoured surface in contact with the flange of the second component for inhibiting a flow of the fluid therethrough.

40. A seal, according to claim 37, wherein each of the contoured surfaces have a radius of about 3.3 mm.

41. A seal, according to claim 37, wherein each of the sealing elements comprises a material having a yield strength within a range of about 450 MPa to about 1,000 MPa.

42. A seal, according to claim 37, wherein each of the sealing elements comprises a material selected from the group consisting of beryllium copper, a nickel/copper alloy, and a nickel/chromium alloy.

43. A seal, according to claim 37, wherein each of the legs further comprises a surface inclined at an angle within a range of about one degree to about 40 degrees with respect to a central axis of the seal.

44. A seal, according to claim 37, wherein each of the first sealing profiles has an interference fit relationship with the inner surface of the first component.

45. A seal for inhibiting a flow of fluid through an annulus defined by a first component and a second component, the seal comprising:
a sealing element disposed within the annulus and comprising:
a first leg terminating in a first sealing profile in contact with an outer surface of the first component for inhibiting a flow of fluid within the annulus in a first direction;
a second leg terminating in a second sealing profile in contact with the outer surface of the first component for inhibiting a flow of the fluid within the annulus in a second direction counter to the first direction; and
an outer surface of the sealing element in a press-fit relationship with a corresponding inner surface of the second component for retaining the sealing element on the second component and for inhibiting a flow of the fluid within the annulus therebetween.

46. A seal, according to claim 45, wherein each of the first and second sealing profiles includes a contoured surface in contact with the surface of the first component to inhibit the flow of the fluid therebetween.

47. A seal, according to claim 46, wherein each of the contoured surfaces have a radius of about 3.3 mm.

48. A seal, according to claim 45, wherein the sealing element comprises a material having a yield strength within a range of about 450 MPa to about 1,000 MPa.

49. A seal, according to claim 45, wherein the sealing element comprises a material selected from the group consisting of beryllium copper, a nickel/copper alloy, and a nickel/chromium alloy.

50. A seal, according to claim 45, wherein the sealing profiles have an interference fit relationship with the outer surface of the first component.

51. A seal, according to claim 45, wherein:
an inside diameter of the first sealing profile is smaller than an inside diameter of the second sealing profile;
the first sealing profile is in contact with a first portion of the outer surface of the first component; and
the second sealing profile is in contact with a second, larger diameter, portion of the outer surface of the first component.

52. A seal, according to claim 45, further comprising a secondary sealing element disposed in a recess defined by the second component and in contact with the first component, such that the fluid within the annulus is inhibited from flowing therebetween.

53. A seal, according to claim 52, wherein the secondary sealing element further comprises an elastomeric material.

54. A seal, according to claim 45, further comprising a retaining nut threadedly engaged with the second component and in contact with the sealing element for further retaining the sealing element on the second component.

55. A seal, according to claim 45, wherein the outer surface of the sealing element and the inner surface of the second component are galled.

56. A seal, according to claim 45, wherein each of the tapered inner surface of the sealing element and the tapered outer surface of the second member further comprise recesses and protrusions that are mechanically meshed for retaining the sealing element on the second component.

57. A seal, according to claim 45, wherein each of the outer surface of the sealing element and the inner surface of the second component has a surface finish of no less than about 0.4 micrometers Rₐ.

58. A seal, according to claim 45, wherein each of the outer surface of the sealing element and the inner surface of the second component has a surface finish within a range of about 0.4 micrometers Rₐ and about 1.6 micrometers Rₐ.

59. A seal for inhibiting a flow of fluid through an annulus defined by a first component and a second component, the seal comprising:
a sealing element disposed within the annulus and comprising:
a first leg terminating in a first sealing profile in contact with an outer surface of the first component for inhibiting a flow of fluid therebetween in a first direction;
a second leg terminating in a second sealing profile in contact with the outer surface of the first component for inhibiting a flow of the fluid therebetween in a second direction counter to the first direction;
a third leg terminating in a third sealing profile in contact with an inner surface of the second component for inhibiting a flow of the fluid therebetween in the first direction; and
a fourth leg terminating in a fourth sealing profile in contact with an inner surface of the second component for inhibiting a flow of the fluid therebetween in the second direction.

60. A seal, according to claim 59, further comprising a retaining nut threadedly engaged with the second component and in contact with the sealing element for further retaining the sealing element in contact with the first component and the second component.

61. A seal, according to claim 59, wherein each of the first and second sealing profiles includes a contoured surface in contact with the surface of the first component to inhibit the flow of the fluid therebetween.

62. A seal, according to claim 61, wherein each of the contoured surfaces have a radius of about 3.3 mm.

63. A seal, according to claim 59, wherein the sealing element comprises a material having a yield strength within a range of about 450 MPa to about 1,000 MPa.

64. A seal, according to claim 59, wherein the sealing element comprises a material selected from the group consisting of beryllium copper, a nickel/copper alloy, and a nickel/chromium alloy.

65. A seal, according to claim 59, wherein the sealing profiles have an interference fit relationship with the outer surface of the first component.

66. A seal, according to claim 59, wherein:
an inside diameter of the first sealing profile is smaller than an inside diameter of the second sealing profile;
the first sealing profile is in contact with a first portion of the outer surface of the first component; and
the second sealing profile is in contact with a second, larger diameter, portion of the outer surface of the first component.

67. A seal, according to claim 59, further comprising a secondary sealing element disposed in a recess defined by the second component and in contact with the first component, such that the fluid within the annulus is inhibited from flowing therebetween.

68. A seal, according to claim 59, wherein the secondary sealing element further comprises an elastomeric material.

69. A method, comprising:
providing a sealing element including at least one sealing profile within an annulus defined by a first component and a second component;
contacting the at least one sealing profile with a surface of the first component to inhibit a flow of fluid therebetween; and
retaining the sealing element on an annulus-side surface of the second component such that a flow of the fluid is inhibited therebetween.

70. A method, according to claim 69, wherein retaining the sealing element further comprises pressing a tapered inner surface of the sealing element onto a correspondingly tapered outer surface of the second component.

71. A method, according to claim 70, wherein retaining the sealing element further comprises galling the inner surface of the sealing element and the outer surface of the second component.

72. A method, according to claim 70, wherein retaining the sealing element further comprises mechanically meshing recesses and protrusions of each of the inner surface of the sealing element and the outer surface of the second component.

73. A method, according to claim 70, wherein retaining the sealing element further comprises heating the sealing element, placing the sealing element on the second component, and allowing the sealing element to cool.

74. A method, according to claim 69, wherein retaining the sealing element further comprises:
threadedly engaging a retaining nut with the second component; and
advancing the threadedly engaged retaining nut into contact with the sealing element.

75. A method, according to claim 74, wherein retaining the sealing element further comprises galling threads of the sealing element and threads of the second component.

76. A method, according to claim 69, wherein retaining the sealing element further comprises:
threadedly engaging a retaining nut with the second component; and
advancing the threadedly engaged retaining nut into contact with the sealing element.

77. A method, according to claim 69, further comprising threadedly engaging the sealing element with the second component.

78. A method, according to claim 69, wherein retaining the sealing element further comprises pressing an outer surface of the sealing element into a corresponding inner surface of the second component.

79. A method, according to claim 78, wherein retaining the sealing element further comprises:
threadedly engaging a retaining nut with the second component; and
advancing the threadedly engaged retaining nut into contact with the sealing element.

80. A method, according to claim 78, wherein retaining the sealing element further comprises galling the outer surface of the sealing element and the inner surface of the second component.

81. A method, according to claim 78, wherein retaining the sealing element further comprises mechanically meshing recesses and protrusions of each of the inner surface of the sealing element and the outer surface of the second component.

82. A method, according to claim 78, wherein retaining the sealing element further comprises heating the second component, placing the sealing element into the second component, and allowing the second component to cool.
